(19) United States
(12) Patent Application Publication
(10) Pub. No.: US 2025/0385319 A1
(43) Pub. Date: Dec. 18, 2025

(54) SECONDARY BATTERY

(71) Applicant: SAMSUNG SDI CO., LTD., Yongin-Si (KR)

(72) Inventor: Taewoong JANG, Yongin-Si (KR)

(21) Appl. No.: 18/933,898

(22) Filed: Oct. 31, 2024

(30) Foreign Application Priority Data
Jun. 12, 2024 (KR) 10-2024-0076654

(51) Int. Cl. H01M 10/0587; H01M 50/169; H01M 50/172; H01M 50/186; H01M 50/193; H01M 50/548; H01M 50/593; H01M 50/595

(52) U.S. Cl. CPC H01M 10/0587; H01M 50/169; H01M 50/172; H01M 50/186; H01M 50/193; H01M 50/548; H01M 50/593; H01M 50/595

(57) ABSTRACT

A secondary battery includes an electrode assembly configured to have a wound structure including a first electrode, a second electrode and a separator between the first electrode and the second electrode; a case having an open area in a first side thereof, the open area being configured to accommodate the electrode assembly; and a cap assembly coupled to the first side of the case and configured to close the open area, wherein the cap assembly includes a cap plate seated in and coupled to the open area of the case and having a through-hole; and a terminal plate including a body and an insertion portion extending through the through-hole of the cap plate, and wherein the first electrode includes an electrode tab having a first end connected to the terminal plate.

### CROSS REFERENCE TO RELATED APPLICATION

The present application claims priority to and the benefit of Korean Application No. 10-2024-0076654, filed on Jun. 12, 2024, in the Korean Intellectual Property Office, the entire disclosure of which is incorporated herein by reference

### BACKGROUND

### 1. Field

Aspects of the present disclosure relates to a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In an example in which components of a secondary battery are coupled, welding is generally used. During the welding process, a weld failure may occur. In such an example, a short circuit may occur in the secondary battery. In an example in which two materials having different polarities in the secondary battery come into electrical contact and an internal short circuit occurs, the temperature of the secondary battery may rise rapidly and, in severe situations, cause a fire.

In particular, a separator of the electrode assembly may become pinched between portions of a cap assembly and a case that are coupled together. In an example in which welding is performed on the portions of the cap assembly and the case that are coupled together, the separator may be damaged or a defective weld may occur, thereby resulting in a defective secondary battery.

The above information disclosed in this Background section is for enhancement of understanding of the background of the present disclosure, and therefore, it may contain information that does not constitute related (or prior) art.

### SUMMARY

Aspects of the present disclosure are directed to a secondary battery configured to overcome the above-described problems.

These and other aspects and features of the present disclosure will be described in or will be apparent from the following description of embodiments of the present disclosure.

According to some embodiments of the present disclosure, there is provided a secondary battery including: an electrode assembly configured to have a wound structure including a first electrode, a second electrode and a separator between the first electrode and the second electrode; a case having an open area in a first side thereof, the open area being configured to accommodate the electrode assembly; and a cap assembly coupled to the first side of the case and configured to close the open area, wherein the cap assembly includes: a cap plate seated in and coupled to the open area of the case and having a through-hole; and a terminal plate including a body and an insertion portion extending through the through-hole of the cap plate, wherein the first electrode includes an electrode tab having a first end connected to the terminal plate, and wherein a lateral end of the body of the terminal plate protrudes beyond the electrode tab in a lateral direction of the case.

In some embodiments, a length of a portion of the body protruding beyond the electrode tab in the lateral direction of the case has a predetermined value or less.

In some embodiments, the body is between the insertion portion and the electrode assembly.

In some embodiments, the electrode tab is bent below the terminal plate in the case, which is configured to accommodates the electrode assembly and to which the cap assembly is coupled.

In some embodiments, the secondary battery further includes an insulating washer between the electrode assembly and the electrode tab, the electrode tab is spaced apart from the electrode assembly by the insulating washer.

In some embodiments, a substrate of the second electrode extends and is wound to wrap around an outer periphery of the electrode assembly.

In some embodiments, the substrate of the second electrode is wrapped around the outer periphery of the electrode assembly in one or more turns.

In some embodiments, the substrate of the second electrode is wrapped around the outer periphery of the electrode assembly in three or fewer turns.

In some embodiments, the substrate of the extended second electrode spaces at least one of the separator or the electrode tab of the electrode assembly from coupled portions of the cap assembly and the case.

In some embodiments, the separator extends and is wound to wrap around an outer periphery of the electrode assembly, and a substrate of the second electrode is wrapped around an outer periphery of the electrode assembly wrapped with the separator.

In some embodiments, the electrode assembly further includes a sealing tape wrapped around at least a portion of an outer periphery of the electrode assembly, and the sealing tape seals the wound electrode assembly.

In some embodiments, the sealing tape includes at least one of polyimides (PI), polyethylene (PE), or polystyrene (PS).

In some embodiments, the body of the terminal plate spaces at least one of the separator or the electrode tab of the electrode assembly from coupled portions of the cap assembly and the case.

In some embodiments, the electrode assembly includes a negative electrode substrate wrapped around an outer periphery of the wound electrode assembly.

According to some embodiments of the present disclosure, there is provided a secondary battery including: an electrode assembly configured to have a wound structure including a first electrode, a second electrode and a separator between the first electrode and the second electrode; a case having an open area in a first side thereof, the open area being configured to accommodate the electrode assembly; and a cap assembly coupled to the first side of the case and configured to close the open area, the cap assembly including: a cap plate seated in and coupled to the open area of the case and having a through-hole and a terminal plate including a body and an insertion portion extending through the through-hole of the cap plate, the first electrode including an electrode tab having a first end connected to the terminal plate; and an insulating washer between the electrode assembly and the electrode tab and configured to space the electrode tab apart from the electrode assembly.

In some embodiments, a substrate of the second electrode is wrapped around an outer periphery of the electrode assembly in one or more turns.

In some embodiments, a substrate of the second electrode is wrapped around an outer periphery of the electrode assembly in three or fewer turns.

In some embodiments, a substrate of the extended second electrode spaces at least one of the separator or the electrode tab of the electrode assembly from coupled portions of the cap assembly and the case.

In some embodiments, the separator extends and is wound to wrap around an outer periphery of the electrode assembly, and a substrate of the second electrode is wrapped around an outer periphery of the electrode assembly wrapped with the separator.

In some embodiments, the electrode assembly further includes a sealing tape wrapped around at least a portion of an outer periphery of the electrode assembly, and the sealing tape seals the wound electrode assembly.

By joining the cap assembly and the case without welding on the contact portions between the cap assembly and the case, defects caused by the welding may be prevented or substantially reduced.

According to some embodiments of the present disclosure, the separator may not be pinched between the case and the cap assembly and may not be damaged by the welding performed on the weld areas. In addition, short circuits that would otherwise result from damage to the first electrode tab caused by the welding on the weld areas may be prevented or the likelihood thereof may be substantially reduced.

According to some embodiments of the present disclosure, in the weld areas, the separator may be prevented from being pinched between the cap assembly and the case or the likelihood thereof may be substantially reduced. That is, damage to the separator may be prevented or substantially reduced.

According to some embodiments of the present disclosure, even when welding is performed on the contact portions between the cap assembly and the case, damage to the separator may be prevented or substantially reduced. Even when welding is performed on the contact portions between the cap assembly and the case, the first electrode tab may be prevented from being damaged by welding or such damage may be substantially reduced.

According to some embodiments of the present disclosure, by wrapping the outer periphery of the electrode assembly with the separator, the second substrate, and the sealing tape, the first electrode tab provided on a first side of the electrode assembly is spaced further away from the outer surface of the electrode assembly. As a result, in the case in which the electrode assembly is accommodated, the distance from the inner surface of the case opposite the outer side of the electrode assembly to the first electrode tab increases. In addition, the second substrate wrapped around the electrode assembly in three or fewer turns may reduce (e.g., minimize) the decrease in energy density of the secondary battery.

According to some embodiments of the present disclosure, the first electrode, the second electrode, the separator, and the negative electrode substrate of the electrode assembly may be prevented from unwinding from the wound state by the sealing tape or the likelihood thereof may be substantially reduced.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a cross-sectional view showing a secondary battery according to some embodiments of the present disclosure;

FIG. 2 illustrates a cross-sectional view showing a secondary battery according to some other embodiments of the present disclosure;

FIG. 3 illustrates a partially enlarged view of the secondary battery according to some other embodiments of the present disclosure;

FIG. 4 illustrates a cross-sectional view showing an electrode assembly according to some embodiments of the present disclosure;

FIG. 5 illustrates a cross-sectional view showing an electrode assembly according to some other embodiments of the present disclosure; and

FIG. 6 illustrates an example of an electrode assembly according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

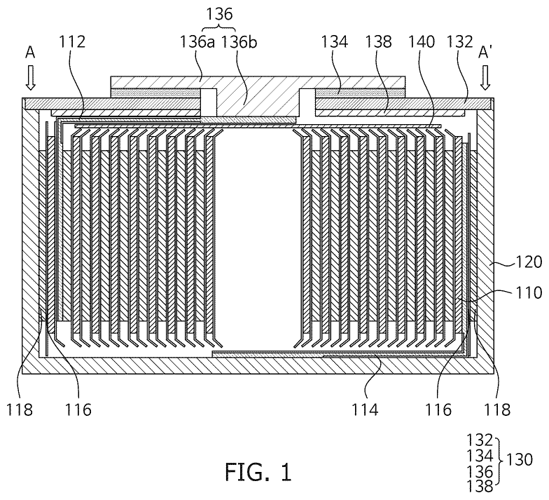

FIG. 1 illustrates a cross-sectional view showing a secondary battery according to some embodiments of the present disclosure. FIG. 1 may illustrate the cross-sectional view taken across the center of the secondary battery in the height direction. The secondary battery may include an electrode assembly 110, a case 120, a cap assembly 130, and an insulating washer 140.

The secondary battery may be a coin or button secondary battery. For example, the secondary battery may be column-shaped. However, this is not intended to be limiting, and the secondary battery may be, for example, a cylindrical, square, or pouch secondary battery.

The electrode assembly 110 may include a first electrode, a second electrode, and a separator. For example, the electrode assembly 110 may have a wound structure with the separator provided between the first electrode and the second electrode. The electrode assembly 110 may be wound to form a winding core, and may have a through-hole in the winding core.

The first electrode may include a first substrate and a first active material layer positioned on the first substrate. A first electrode tab 112 may extend outward from a first uncoated portion of the first substrate where the first active material layer is not provided, and the first electrode tab 112 may be electrically connected to a terminal plate 136 of the cap assembly 130.

The second electrode may include a second substrate and a second active material layer disposed on the second substrate. A second electrode tab 114 may extend outward from a second uncoated portion of the second substrate where the second active material layer is not provided, and may be electrically connected to the case 120. The first electrode tab 112 and the second electrode tab 114 may extend in opposite directions from each other.

In some embodiments, each of the first electrode tab 112 and the second electrode tab 114 may be covered with a cover tape. The cover tape may include an insulating material. In such examples, the insulating material may provide electrical insulation to prevent the transmission of current. The cover tape may prevent or substantially reduce the likelihood of short circuits on the first electrode tab 112 and the second electrode tab 114.

The first electrode may function as a positive electrode. In such examples, the first substrate may include, for example, an aluminum (Al) foil, and the first active material layer may include, for example, a transition metal oxide. The second electrode may function as a negative electrode. In such examples, the second substrate may include, for example, a copper foil or a nickel foil, and the second active material layer may include, for example, graphite.

The separator may function to prevent the first and second electrodes from short circuiting while allowing lithium ions to migrate. The separator may include, for example, but is not limited to, a polyethylene film, a polypropylene film, a polyethylene-polypropylene film, and/or the like.

Referring to FIG. 1, the first electrode tab 112 of the first electrode may be provided on a first side of the electrode assembly 110. The second electrode tab 114 of the second electrode may be provided on a second side of the electrode assembly 110. However, this is not intended to be limiting, and the first electrode tab and the second electrode tab may be provided on a single side of the electrode assembly 110.

The case 120 contains the electrode assembly 110 and the electrolyte and, together with the cap assembly 130, forms the exterior of the secondary battery. The case 120 may include a substantially cylindrical sidewall and a bottom connected to a first side of the sidewall. However, the case 120 is not limited thereto, and the case 120 may be configured in a variety of shapes, including a circular shape, a pouch, and the like. In addition, the case may include a metal, such as aluminum (Al), an Al alloy, nickel (Ni) plated steel, or a laminated film or plastic that forms the pouch.

The case 120 may contain the electrode assembly 110. The electrode assembly 110 may be inserted into the case 120 through an open area provided in a first side of the case 120. The open area of the case 120 may then be sealed with a cap assembly 130. The cap assembly 130 may be coupled to the first side of the case 120.

The cap assembly 130 may include a cap plate 132, an insulating layer 134, the terminal plate 136, and an insulating member 138. Herein, the cap plate 132 may cover an open area of the case 120. The cap plate 132 may be coupled to a side surface of the case 120 corresponding to a side surface of the open area.

The cap plate 132 may have an insertion hole provided therein. For example, the insertion hole may be provided in the central portion of the cap plate 132. The terminal plate 136 may be inserted into the insertion hole such that the terminal plate 136 is coupled to the cap plate 132. The terminal plate 136 may include a body 136a and an insertion portion 136b protruding from the body 136a. Herein, the insertion portion 136b of the terminal plate 136 may be inserted into the insertion hole of the cap plate 132. In addition, the insertion portion 136b of the terminal plate 136 may contact and be connected to the first electrode tab 112. Referring to FIG. 1, the cap assembly 130 including the terminal plate 136 may be coupled to the case 120 such that the insertion portion 136b faces the electrode assembly.

The insulating layer 134 may be disposed between the terminal plate 136 and the cap plate 132. The insulating layer 134 may include an adhesive to bond the terminal plate 136 and the cap plate 132. The insulating layer 134 may include an insulating material to electrically insulate the terminal plate 136 and the cap plate 132 from each other.

In some embodiments, the insulating member 138 may be disposed on the bottom surface of the cap plate 132. Herein, the top surface of the cap plate 132 may face the body 136a of the terminal plate 136, and the bottom surface of the cap plate 132 may face the electrode assembly. The insulating member 138 may include an insulating material that may insulate the cap plate 132 and the electrode assembly 110 from each other or the cap plate 132 and the first electrode tab 112 from each other.

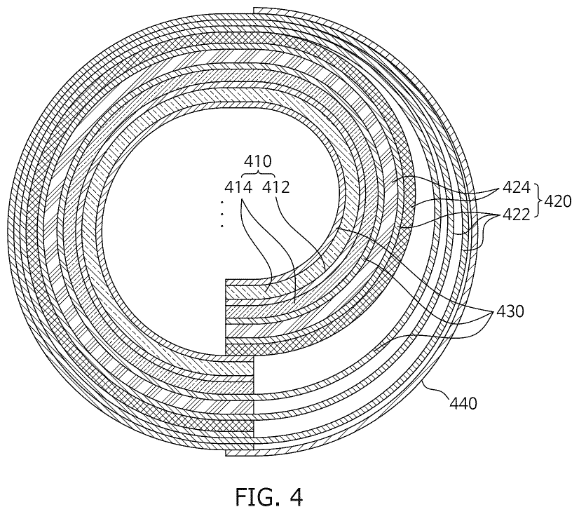

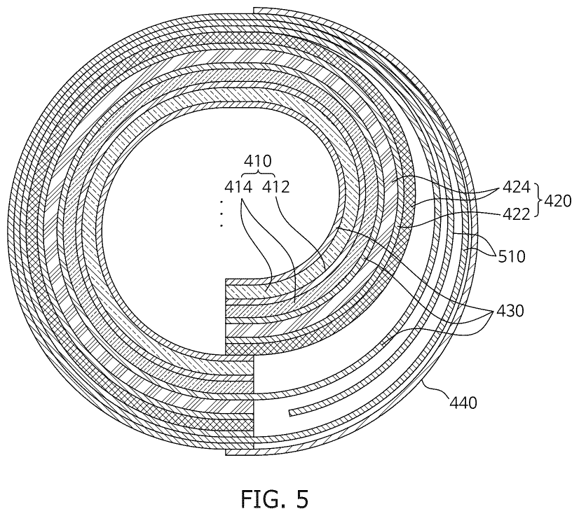

In some embodiments, the electrode assembly 110 may include a negative electrode substrate (e.g., negative electrode material) 116 wrapped around the outer periphery thereof. In such examples, the negative electrode substrate 116 may be made of the same material as the substrate of the second electrode. In some other embodiments, in the electrode assembly 110, the substrate of the second electrode may extend and be wound to wrap around the outer periphery of the electrode assembly. In such examples, a substrate of the second electrode may be a negative electrode substrate. The second electrode substrate or negative electrode substrate (e.g., negative electrode material) 116 wrapped with the electrode assembly 110 is described in more detail with reference to FIGS. 4 and 5.

In some embodiments, the electrode assembly 110 may include a sealing tape 118 wrapped around at least a portion of the outermost periphery of the electrode assembly 110. Herein, the sealing tape 118 may seal the wound electrode assembly 110. For example, the first electrode, the second electrode, and the separator of the electrode assembly 110 may be maintained in the wound state by the sealing tape 118 without unwinding. For example, the sealing tape may include an adhesive and be bonded to at least a portion of the outermost periphery of the electrode assembly 110. The sealing tape may include an insulating material. For example, the sealing tape may include at least one of polyimide (PI), polyethylene (PE), or polystyrene (PS).

In some embodiments, the first electrode tab 112 may be bent under the terminal plate 136 in the case 120 which accommodates the electrode assembly 110 and to which the cap assembly 130 is coupled. The bent first electrode tab 112 may be prevented from short circuiting with the electrode assembly 110 by the insulating washer 140 or the likelihood may be substantially reduced. The insulating washer 140 may be disposed between the electrode assembly 110 and the terminal plate 136. For example, the insulating washer 140 may be disposed between the first electrode tab 112 positioned under the terminal plate 136 and the electrode assembly 110. The insulating washer 140 may include an insulating material. The insulating washer 140 may provide a space between the first electrode tab 112 and the electrode assembly 110. In addition, the insulating washer 140 may electrically insulate the first electrode tab 112 and the electrode assembly 110 from each other.

The contact portions between the case 120 and the cap assembly 130 may be welded to join the case 120 and the cap assembly 130 together. Referring to FIG. 1, welding may be performed on weld areas A and A′ to join the case 120 and the cap assembly 130 together. The separator of the electrode assembly 110 may be longer than each of the first electrode and the second electrode in the height direction of the electrode assembly 110. The negative electrode substrate 116 wrapped around the outer periphery of the electrode assembly 110 may increase the distances of a first end of the separator of the electrode assembly 110 from the weld areas A and A′. Similarly, the negative electrode substrate 116 may increase the distances of the first electrode tab 112 of the electrode assembly 110 from the weld areas A and A′. As a result, the separator may not be pinched between the case 120 and the cap assembly 130 and may not be damaged by the welding performed on the weld areas A and A′. In addition, short circuits that would otherwise result from damage to the first electrode tab 112 caused by the welding on the weld areas A and A′ may be prevented or the likelihood of such damage may be substantially reduced.

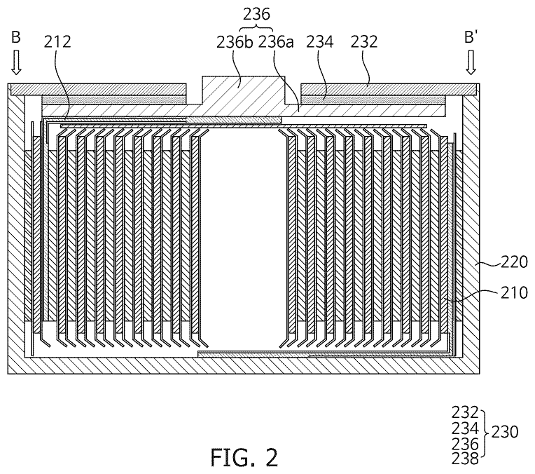

FIG. 2 illustrates a cross-sectional view showing a secondary battery according to some other embodiments of the present disclosure. The secondary battery shown in FIG. 2 may be the same or substantially the same as the secondary battery of FIG. 1, except for the cap assembly 130 of the secondary battery of FIG. 1. The secondary battery of FIG. 2 is described primarily with respect to a cap assembly 230 of FIG. 2.

A cap plate 232 may have an insertion hole provided therein. For example, the insertion hole may be provided in the central portion of the cap plate 232. A terminal plate 236 may be inserted into the insertion hole, thereby being coupled to the cap plate 132. The terminal plate 236 may include a body 236a and an insertion portion 236b protruding from the body 236a. Herein, the insertion portion 236b of the terminal plate 236 may be inserted into an insertion hole of the cap plate 232. In addition, the body 236a of the terminal plate 236 may be positioned below the cap plate 232. The terminal plate 236 may contact and be connected to the first electrode tab 112. Referring to FIG. 2, the cap assembly 230 including the terminal plate 236 such that the body 236a faces the electrode assembly may be coupled to a case 220.

The insulating layer 234 may be disposed between the terminal plate 236 and the cap plate 232. The insulating layer 234 may include an adhesive to bond the terminal plate 236 and the cap plate 232. The insulating layer 234 may include an insulating material to electrically insulate the terminal plate 236 and the cap plate 232 from each other.

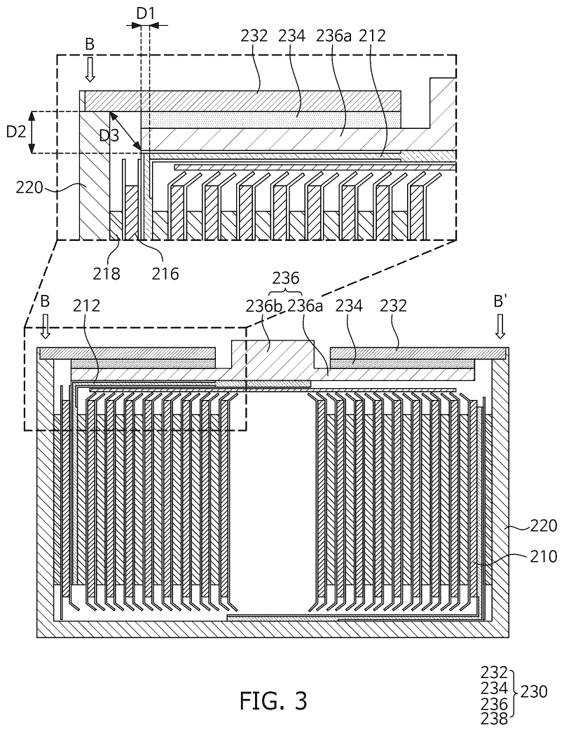

The contact portions between the case 220 and the cap assembly 230 may be welded to join the case 220 and the cap assembly 230 together. Referring to FIG. 1, welding may be performed on weld areas B and B′ to join the case 220 and the cap assembly 230 together. Each of the weld areas B and B′ may be spaced apart from the electrode assembly 210 by a distance equal to or greater than a combined thickness of the body 236a of the terminal plate 236 and the insulating layer 234. The distance between each of the weld areas B and B′ and the electrode assembly 210 will be described in more detail with reference to FIG. 3.

A lateral end of the body 236a of the terminal plate 236 may protrude beyond a first electrode tab 212 in a lateral direction of the case 220. The lateral end of the terminal plate 236 will be described in more detail with reference to FIG. 3.

FIG. 3 illustrates a partially enlarged view of the secondary battery according to some other embodiments of the present disclosure. For example, FIG. 3 may show a partially enlarged shape of the contact portions between the cap assembly 230 and the case 220 in the secondary battery of FIG. 2.

The body 236a may extend in a lateral direction of the case 220. A lateral end of the body 236a may protrude beyond the first electrode tab 212 in the lateral direction of the case 220. The protruding length D1 of the lateral end of the body may be less than a combined thickness of the negative electrode substrate (e.g., negative electrode material) 216 and the sealing tape 218 wrapped around the electrode assembly 210. In such examples, the thickness of the negative electrode substrate 216 wrapped around the electrode assembly 210 may be proportional to the number of turns of the negative electrode substrate 216 wrapped around the electrode assembly 210. For example, in examples in which the negative electrode substrate 216 wrapped around the electrode assembly 210 is wound in two turns (i.e., is wound twice), the thickness of the negative electrode substrate 216 wrapped with the electrode assembly 210 may be equal to twice the thickness of the negative electrode substrate 216.

A wound separator positioned in the direction of the winding core of the electrode assembly 210 from the first electrode tab 212 may be covered with the body 236a having the protruding lateral end. In addition, welding may be performed on the coupled portions of the cap assembly 230 and the case 220. It may be difficult for the separator covered with the body 236a to reach the weld areas B and B′. As a result, the separator covered with the body 236a may avoid being pinched between the cap assembly 230 and the case 220 in the weld areas B and B′ or the likelihood of such pinching may be substantially reduced.

In some embodiments, the body 236a of the terminal plate 236 may be disposed between the cap plate 232 and the electrode assembly 210. The electrode assembly 210 may be spaced apart from the cap plate 232 by a combined thickness D2 of the body and the insulating layer. As a result, the shortest distance D3 between the electrode assembly 210 and the weld areas B and B′ may be relatively increased. In such examples, the separator protruding from a first side of the electrode assembly 210 may be shorter than the shortest distance D3 between the electrode assembly 210 and the weld areas B and B′, thereby being prevented from being pinched between the cap assembly 230 and the case 220 in the weld areas B and B′, or the likelihood of such pinching may be substantially reduced.

Because the separator is prevented from being pinched between the cap assembly 230 and the case 220, damage to the separator may be prevented or substantially reduced. In addition, as the shortest distance D3 between the electrode assembly and the edge increases, damage to the separator may be prevented or substantially reduced, even when welding is performed on the contact portions between the cap assembly 230 and the case 220. Similarly, as the shortest distance D3 between the electrode assembly and the edge increases, the first electrode tab 212 may avoid being damaged by welding, even when welding is performed on the contact portions between the cap assembly 230 and the case 220.

FIG. 4 illustrates a cross-sectional view showing an electrode assembly according to some embodiments of the present disclosure. For example, FIG. 4 may show the cross-sectional view of the electrode assembly taken in a direction perpendicular to the height direction of the electrode assembly. The electrode assembly may have a wound structure including a first electrode 410, a second electrode 420, and a separator 430. In such examples, the separator 430 may be provided between the first electrode 410 and the second electrode 420. In FIG. 4, some of the first electrode 410, the second electrode 420, and the separator 430 wound toward the center of the electrode assembly may be omitted, but this is not intended to be limiting.

The first electrode 410 may have first active material layers 414 positioned on opposite surfaces of a first substrate 412. For example, the first electrode 410 may act as a positive electrode, the first substrate 412 may be a positive electrode substrate, and the first active material layers 414 may be positive electrode active material layers. The second electrode 420 may have second active material layers 424 positioned on opposite surfaces of a second substrate (e.g., a second material) 422. For example, the second electrode 420 may act as a negative electrode, the second substrate 422 may be a negative electrode substrate, and the second active material layers 424 may be negative electrode active material layers. A separator 430 may be provided between the first electrode 410 and the second electrode 420 to prevent the first electrode 410 and the second electrode 420 from short circuiting or may substantially reduce the likelihood thereof.

In some embodiments, the separator 430 may extend and be wound to wrap around the outer periphery of the electrode assembly. Referring to FIG. 4, the separator 430 is shown extending and wound to wrap around the electrode assembly in one turn, but the present disclosure is not limited thereto. For example, the separator 430 may be wrapped around the outer periphery of the electrode assembly in more than one turn. In other examples, the separator 430 may be wrapped around the outer periphery of the electrode assembly in at least a portion of one turn.

In some embodiments, the second substrate 422, which is a substrate (or base) of the second electrode, may extend and be wound to wrap around the outer periphery of the electrode assembly. In examples in which the separator 430 extends and is wound around the outer periphery of the electrode assembly, the second substrate 422 may be wrapped around the outer periphery of the electrode assembly wrapped with the separator 430. Referring to FIG. 4, the second substrate 422 is shown wrapped in two turns around the outer periphery of the electrode assembly wrapped with the separator 430, but the present disclosure is not limited thereto. For example, the second substrate 422 may be wrapped around the outer periphery of the electrode assembly where the separator 430 does not extend or is not wrapped. For example, the second substrate 422 may extend and be wound to wrap around the outer periphery of the electrode assembly in one or more turns. For example, the second substrate 422 may extend and be wound to wrap around the outer periphery of the electrode assembly in three or fewer turns.

In some embodiments, the electrode assembly may include a sealing tape 440 wrapped around at least a portion of the outermost periphery of the electrode assembly. The sealing tape 440 may seal the wound electrode assembly. For example, the sealing tape 440 may extend to cover an end of the wound second substrate 422 or the separator 430 in the winding direction. The first electrode 410, the second electrode 420, and the separator 430 of the electrode assembly may be maintained in the wound state by the sealing tape 440 without unwinding. Referring to FIG. 4, the sealing tape 440 is shown wrapped around the outermost periphery of the electrode assembly in a half turn, but the present disclosure is not limited thereto. For example, the sealing tape 440 may be wrapped around at least a portion of the outermost periphery of the electrode assembly in at least a portion of one turn.

By wrapping the outer periphery of the electrode assembly with the separator 430, the second substrate 422, and the sealing tape 440, the first electrode tab provided on a first side of the electrode assembly is spaced further away from the outer surface of the electrode assembly. As a result, in the case in which the electrode assembly is accommodated, the distance from the inner surface of the case opposite the outer side of the electrode assembly to the first electrode tab increases. In addition, the second substrate 422 wrapped around the electrode assembly in three or fewer turns may reduce (e.g., minimize) the decrease in energy density of the secondary battery.

FIG. 5 illustrates a cross-sectional view showing an electrode assembly according to some other embodiments of the present disclosure. The electrode assembly shown in FIG. 5 may be the same or substantially the same as the electrode assembly of FIG. 4, except that the second substrate 422 of the electrode assembly of FIG. 4 extends and is wound. Referring to FIG. 5, features different from those of the electrode assembly of FIG. 4 are primarily described.

In some embodiments, a negative electrode substrate (e.g., negative electrode material) 510 may be wound to wrap around the outer periphery of the electrode assembly. In such examples, the negative electrode substrate 510 may be made of the same material as the second substrate 422 of the second electrode 420. In examples in which the separator 430 extends to wrap around the outer periphery of the electrode assembly, the negative electrode substrate 510 may be wrapped around the outer periphery of the electrode assembly wrapped with the separator 430. Referring to FIG. 5, the negative electrode substrate 510 is shown wrapped in two turns around the outer periphery of the electrode assembly wrapped with the separator 430, but the present disclosure is not limited thereto. For example, the negative electrode substrate 510 may be wrapped around the outer periphery of the electrode assembly where the separator 430 does not extend or is not wrapped. For example, the negative electrode substrate 510 may be wrapped around the outer periphery of the electrode assembly in one or more turns. For example, the negative electrode substrate 510 may be wrapped around the outer periphery of the electrode assembly in three or fewer turns.

In some embodiments, the electrode assembly may include a sealing tape 440 wrapped around at least a portion of the outermost periphery of the electrode assembly. The sealing tape 440 may seal the wound electrode assembly. For example, the sealing tape 440 may cover an end of the negative electrode substrate 510 or the separator 430 in the winding direction. The first electrode 410, the second electrode 420, the separator 430, and the negative electrode substrate 510 of the electrode assembly may avoid unwinding from the wound state by the sealing tape 440.

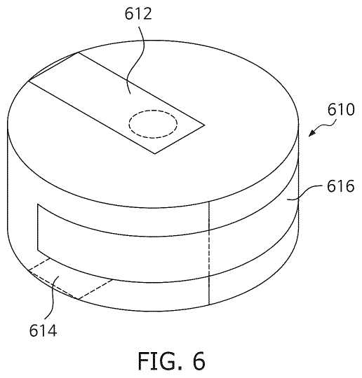

FIG. 6 illustrates an example of an electrode assembly 610 according to some embodiments of the present disclosure. For example, FIG. 6 may illustrate a view of a sealing tape 616 configured to seal the electrode assembly 610.

The electrode assembly 610 may have a wound structure including a first electrode, a second electrode, and a separator provided between the first electrode and the second electrode. In some embodiments, the separator may extend and be wound to wrap around the outer periphery of the electrode assembly. In addition, a substrate of the second electrode (or second electrode substrate) may be wrapped around the outer periphery of the electrode assembly wrapped with the separator. In other examples, a negative electrode substrate may be wrapped around the outer periphery of the electrode assembly wrapped with the separator.

An end of the second electrode substrate (or negative electrode substrate) in the winding direction may be positioned on a side surface of the electrode assembly 610. In such examples, the sealing tape 616 may be attached to at least a portion of the outermost periphery of the electrode assembly 610 while covering the end. As a result, the electrode assembly 610 may be sealed to prevent the first electrode, the second electrode, and the separator or the first electrode, the second electrode, the separator, and the negative electrode substrate included in the electrode assembly 610 from unwinding.

In some embodiments, a first electrode tab 612 may be provided on a first side of the electrode assembly 610. The first electrode tab 612 may be connected to a first electrode. The first electrode tab 612 may be connected to a terminal plate in a case which accommodates the electrode assembly 610 and to which the cap assembly is coupled. In such examples, the first electrode tab 612 below the terminal plate may be bent toward the electrode assembly 610. In some embodiments, the first electrode tab 612 may be bent to be positioned over the winding core of the electrode assembly 610.

In some embodiments, a second electrode tab 614 may be provided on a second side of the electrode assembly 610. The second electrode tab 614 may be connected to a second electrode. In examples in which the electrode assembly 610 is coupled with the cap assembly, the second electrode tab 614 may be connected to a bottom portion of the case. In such examples, the second electrode tab 614 may be bent over the bottom portion of the case toward the electrode assembly 610. In some embodiments, the second electrode tab 614 may be bent to be positioned over the winding core of the electrode assembly 610.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A secondary battery comprising:
an electrode assembly configured to have a wound structure comprising a first electrode, a second electrode and a separator between the first electrode and the second electrode;
a case having an open area in a first side thereof, the open area being configured to accommodate the electrode assembly; and
a cap assembly coupled to the first side of the case and configured to close the open area,
wherein the cap assembly comprises:
a cap plate seated in and coupled to the open area of the case and having a through-hole; and
a terminal plate comprising a body and an insertion portion extending through the through-hole of the cap plate,
wherein the first electrode comprises an electrode tab having a first end connected to the terminal plate, and
wherein a lateral end of the body of the terminal plate protrudes beyond the electrode tab in a lateral direction of the case.

2. The secondary battery as claimed in claim 1, wherein a length of a portion of the body protruding beyond the electrode tab in the lateral direction of the case has a predetermined value or less.

3. The secondary battery as claimed in claim 1, wherein the body is between the insertion portion and the electrode assembly.

4. The secondary battery as claimed in claim 1, wherein the electrode tab is bent below the terminal plate in the case, which is configured to accommodates the electrode assembly and to which the cap assembly is coupled.

5. The secondary battery as claimed in claim 1, further comprising an insulating washer between the electrode assembly and the electrode tab,
wherein the electrode tab is spaced apart from the electrode assembly by the insulating washer.

6. The secondary battery as claimed in claim 1, wherein a substrate of the second electrode extends and is wound to wrap around an outer periphery of the electrode assembly.

7. The secondary battery as claimed in claim 6, wherein the substrate of the second electrode is wrapped around the outer periphery of the electrode assembly in one or more turns.

8. The secondary battery as claimed in claim 6, wherein the substrate of the second electrode is wrapped around the outer periphery of the electrode assembly in three or fewer turns.

9. The secondary battery as claimed in claim 6, wherein the substrate of the extended second electrode spaces at least one of the separator or the electrode tab of the electrode assembly from coupled portions of the cap assembly and the case.

10. The secondary battery as claimed in claim 1, wherein the separator extends and is wound to wrap around an outer periphery of the electrode assembly, and a substrate of the second electrode is wrapped around an outer periphery of the electrode assembly wrapped with the separator.

11. The secondary battery as claimed in claim 1, wherein the electrode assembly further comprises a sealing tape wrapped around at least a portion of an outer periphery of the electrode assembly, and
wherein the sealing tape seals the wound electrode assembly.

12. The secondary battery as claimed in claim 11, wherein the sealing tape comprises at least one of polyimides (PI), polyethylene (PE), or polystyrene (PS).

13. The secondary battery as claimed in claim 1, wherein the body of the terminal plate spaces at least one of the separator or the electrode tab of the electrode assembly from coupled portions of the cap assembly and the case.

14. The secondary battery as claimed in claim 1, wherein the electrode assembly comprises a negative electrode substrate wrapped around an outer periphery of the wound electrode assembly.

15. A secondary battery comprising:
an electrode assembly configured to have a wound structure comprising a first electrode, a second electrode and a separator between the first electrode and the second electrode;
a case having an open area in a first side thereof, the open area being configured to accommodate the electrode assembly; and
a cap assembly coupled to the first side of the case and configured to close the open area, the cap assembly comprising: a cap plate seated in and coupled to the open area of the case and having a through-hole and a terminal plate comprising a body and an insertion portion extending through the through-hole of the cap plate, the first electrode comprising an electrode tab having a first end connected to the terminal plate; and
an insulating washer between the electrode assembly and the electrode tab and configured to space the electrode tab apart from the electrode assembly.

16. The secondary battery as claimed in claim 15, wherein a substrate of the second electrode is wrapped around an outer periphery of the electrode assembly in one or more turns.

17. The secondary battery as claimed in claim 15, wherein a substrate of the second electrode is wrapped around an outer periphery of the electrode assembly in three or fewer turns.

18. The secondary battery as claimed in claim 15, wherein a substrate of the extended second electrode spaces at least one of the separator or the electrode tab of the electrode assembly from coupled portions of the cap assembly and the case.

19. The secondary battery as claimed in claim 15, wherein the separator extends and is wound to wrap around an outer periphery of the electrode assembly, and a substrate of the second electrode is wrapped around an outer periphery of the electrode assembly wrapped with the separator.

20. The secondary battery as claimed in claim 15, wherein the electrode assembly further comprises a sealing tape wrapped around at least a portion of an outer periphery of the electrode assembly, and
wherein the sealing tape seals the wound electrode assembly.
